(19) United States
(12) Patent Application Publication
(10) Pub. No.: US 2009/0117422 A1
(43) Pub. Date: May 7, 2009

(54) Balanced Humidity by Cross Coupling WVT and Stack Cathode Flow Paths

(75) Inventors: Thomas Weispfenning, Ober-Ramstadt (DE); Marc Becker, Idstein (DE); Matthias Hampel, Ruesselsheim (DE)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 11/936,614

(22) Filed: Nov. 7, 2007

(51) Int. Cl. H01M 8/18; H01M 8/04

(52) U.S. Cl. 429/17; 429/19

(57) ABSTRACT

A fuel cell system that includes a first fuel cell stack and a second fuel cell stack in a divided stack design. A first water vapor transfer unit is used to humidify the cathode inlet to the first divided stack and a second water vapor transfer unit is used to humidify the cathode inlet air to the second divided stack. The cathode exhaust gas from the divided stacks is used to provide the humidification for the water vapor transfer units. In order to provide relative humidity balancing between the first and second divided stacks, the cathode inlet air flowing through one of the WVT units is sent to one of the divided stacks that receives the cathode exhaust gas from the other divided stack and vice versa.

### BACKGROUND OF THE INVENTION

1. Field of the Invention

This invention relates generally to a fuel cell system for humidifying the cathode inlet airflow to split fuel cell stacks, where the fuel cell system includes two water vapor transfer (WVT) units that humidify the cathode inlet airflow to the split stacks and, more particularly, to a fuel cell system for humidifying the cathode inlet airflow to split fuel cell stacks, where the fuel cell system includes two water vapor transfer (WVT) units that humidify the cathode inlet airflow to the split stacks and where the cathode outlet gas of one split stack is used to humidify the cathode inlet airflow to the other split stack so as to provide humidity balancing between the split stacks.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode inlet gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

As is well understood in the art, fuel cell membranes operate with a certain relative humidity (RH) so that the ionic resistance across the membrane is low enough to effectively conduct protons. The relative humidity of the cathode outlet gas from the fuel cell stack is typically controlled to control the relative humidity of the membranes by controlling several stack operating parameters, such as stack pressure, temperature, cathode stoichiometry and the relative humidity of the cathode air into the stack.

During operation of the fuel cell, moisture from the MEAs and external humidification may enter the anode and cathode flow channels. At low cell power demands, typically below 0.2 A/cm², water may accumulate within the flow channels because the flow rate of the reactant gas is too low to force the water out of the channels. As the water accumulates, it forms droplets that continue to expand because of the relatively hydrophobic nature of the plate material. The contact angle of the water droplets is generally about 80°-90° in that the droplets form in the flow channels substantially perpendicular to the flow of the reactant gas. As the size of the droplets increases, the flow channel is closed off, and the reactant gas is diverted to other flow channels because the channels are in parallel between common inlet and outlet manifolds.

Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

Low performing cells, especially at low stack power output, is a problem in fuel cell applications. Low performing cells typically produce more water than other cells, which can lead to flow channel flooding. One flooded cell can start a downward spiral of operation that may ultimately lead to stack failure, especially during low-power operation. As discussed above, the most common cause of low performing cells and fuel cell stack failure is significant cell-to-cell variation as a result of water holdup caused by stochastic variations in gas behavior dynamics.

As mentioned above, water is generated as a by-product of the stack operation. Therefore, the cathode exhaust gas from the stack will include water vapor and liquid water. It is known in the art to use a water vapor transfer (WVT) unit to capture some of the water vapor in the cathode exhaust gas, and use the water vapor to humidify the cathode inlet airflow. Water in the cathode exhaust gas flowing down the flow channels at one side of the membrane is absorbed by the membrane and transferred to the cathode air stream flowing down the flow channels at the other side of the membrane.

FIG. 1 is a schematic plan view of a fuel cell system 10 including a split or divided stack design having a first fuel cell stack 12 and a second fuel cell stack 14. The system 10 can include any suitable anode sub-system, such as an anode sub-system that employs flow shifting, stack order switching, anode recycling, etc. Cathode inlet air from a compressor 16 is sent to cathode inlet lines 18 and 20 and the cathode flow channels of the stacks 12 and 14, respectively. Cathode exhaust gas is output from the stack 12 on line 22 and cathode exhaust gas is output from the stack 14 on line 24. A water vapor transfer (WVT) unit 26 receives the cathode inlet air to the stack 12 flowing through the line 18 and the cathode exhaust gas from the stack 12 on the line 22. The humidity and water vapor generated by the stack 12 that is output on the cathode exhaust gas line 22 is used to humidify the input gas in the WVT unit 26. Likewise, the cathode inlet air flowing in the inlet line 20 to the stack 14 flows through a WVT unit 28 and the cathode exhaust gas flowing in the exhaust gas line 24 is sent to the WVT unit 28 to humidify the cathode inlet air. Although the WVT units 26 and 28 are shown as separate units, it is likely that they would be separate WVT units in a common housing. The control of the speed of the compressor 16, the relative humidity of the cathode inlet air and the relative humidity of the cathode exhaust gas is controlled by a control system (not shown) as would be well understood to those skilled in the art.

As discussed above, a single compressor provides the cathode inlet airflow to the stacks 12 and 14. The amount of flow sent to the stacks 12 and 14 depends on the flow resistance in the stacks 12 and 14, mostly provided by the cathode flow channels within the stacks 12 and 14 and partly provided by the flow channels within the WVT units 26 and 28. The difference in the flow resistances in the stacks 12 and 14 and the WVT units 26 and 28 is a result of manufacturing tolerances, and typically cannot be improved. Therefore, an unequal flow distribution occurs in the stacks 12 and 14 that provides different humidity levels in the stacks 12 and 14 as a result of the amount of water generated in the stacks 12 and 14. Particularly, for a certain current density produced by the stacks 12 and 14 for a load request, the amount of water generated in the stacks 12 and 14 would be about the same. Because there is less airflow through the cathode side of the stack with the higher resistance, there is less airflow to dry the membranes, which provides more water at the output of the stack with the higher flow resistance. The more water at the cathode output of the stack with the higher flow resistance transfers more water to the WVT unit, which increases the amount of humidity entering the stack. This water cycling could cause the cathode flow channels to be blocked with water that could lead to possible stack failure.

For example, assume a flow resistance in the stack 12 that is larger than the flow resistance in the stack 14. This leads to a lower flow in the cathode flow channels of the stack 12 than the cathode flow channels in the stack 14. The amount of water generated by the stacks 12 and 14 is the same because the currents drawn by both stacks 12 and 14 is the same. This leads to a higher outlet humidity of the cathode exhaust gas from the stack 12 because of the lower airflow therethrough. The more water in the cathode exhaust gas from the stack 12 increases the amount of water transferred in the water vapor transfer unit 26, which results in an increased relative humidity of the cathode inlet air to the stack 12, which again increases the amount of water in the cathode exhaust gas of the stack 12.

This same problem also leads to a lower than desired outlet humidity from the other lower flow resistant stack because there is more airflow which creates a drying effect on the membranes, which leads to less water vapor in the cathode exhaust gas, which provides less water transfer in the WVT unit.

### SUMMARY OF THE INVENTION

In accordance with the teachings of the present invention, a fuel cell system is disclosed that includes a first fuel cell stack and a second fuel cell stack in a divided stack design. A first water vapor transfer unit is used to humidify the cathode inlet airflow to the first divided stack and a second water vapor transfer unit is used to humidify the cathode inlet airflow to the second divided stack. The cathode exhaust gas from the divided stacks is used to provide the humidification for the water vapor transfer units. In order to provide relative humidity balancing between the first and second fuel cell stacks, the cathode inlet air flowing through one of the WVT units that is sent to one of the fuel cell stacks receives the cathode exhaust gas from the other fuel cell stack and vice versa.

Additional features of the present invention will become apparent from the following description and appended claims, taken in conjunction with the accompanying drawings.

### BRIEF DESCRIPTION OF THE DRAWINGS

FIG. 1 is a schematic plan view of a known fuel cell system including split fuel cell stacks and separate water vapor transfer units for humidifying the cathode inlet gas to the split stacks;

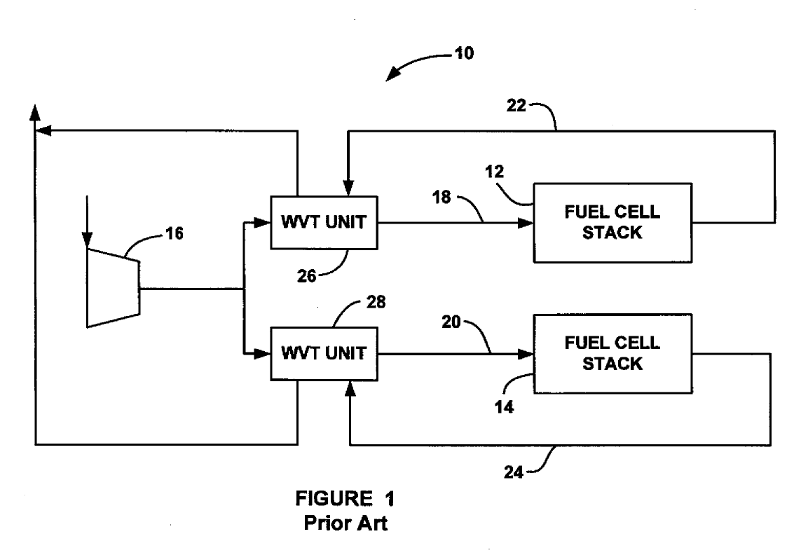

FIG. 2 is a schematic plan view of a fuel cell system including split fuel cell stacks, where the cathode inlet air to one split stack flows through one WVT unit and the cathode exhaust gas from the other split stack is used to humidify the one WVT unit, according to one embodiment of the present invention; and

FIG. 3 is a schematic plan view of a fuel cell system including split fuel cell stacks, where the cathode inlet air to one split stack flows through one WVT unit and the cathode exhaust gas from the other split stack is used to humidify the one WVT unit, according to another embodiment of the present invention.

### DETAILED DESCRIPTION OF THE EMBODIMENTS

The following discussion of the embodiments of the invention directed to a fuel cell system including divided fuel cell stacks and separate water vapor transfer units for humidifying the split stacks is merely exemplary in nature, and is in no way intended to limit the invention or its applications or uses.

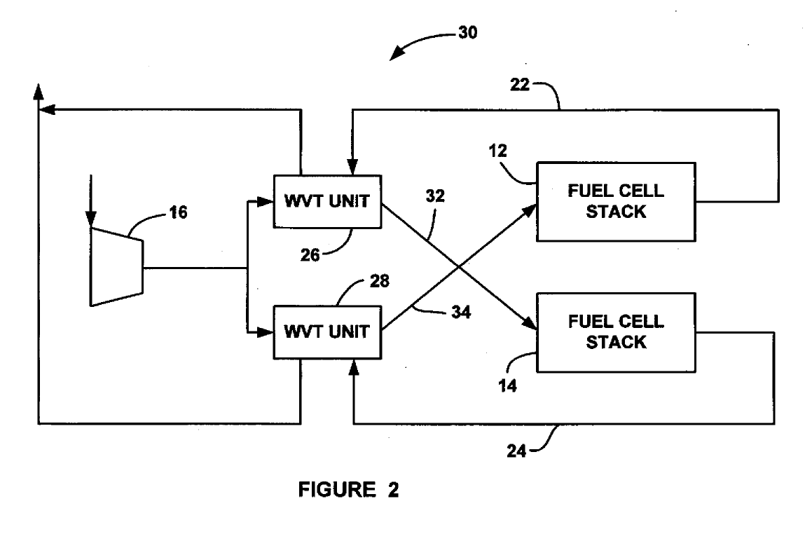

FIG. 2 is a schematic plan view of a fuel cell system 30 that is similar to the fuel cell system 10, where like elements are identified by the same reference numeral, according to an embodiment of the present invention. In this design, the cathode inlet line 18 to the stack 12 is replaced with a cathode inlet line 32 coupled to the stack 14 and the cathode inlet line 20 to the stack 14 is replaced with a cathode inlet line 34 coupled to the stack 12. Therefore, the cathode inlet air that is humidified by the WVT 28 flows into the cathode flow channels of the stack 12 and the cathode exhaust gas flowing through the line 22 from the stack 12 is used to humidify the WVT unit 26. Likewise, the cathode inlet air to the stack 14 is humidified by the WVT unit 26 and the cathode exhaust gas flowing through the line 24 from the stack 14 is used to humidify the cathode air flowing to the stack 12. Although the WVT units 26 and 28 are shown as separate units, they could be separate WVT units provided in a common housing.

This configuration of the system 10 provides good relative humidity balancing between the cathode side of the fuel cells in the stacks 12 and 14. For example, assume that the cathode flow resistance in the stack 12 is higher than the cathode flow resistance in the stack 14. As discussed above, this leads to a higher humidity of the cathode exhaust gas from the stack 12 because of the lower airflow through the stack 12. However, because the cathode exhaust gas from the stack 12 is sent to the WVT unit 26, it humidifies the cathode inlet air to the stack 14 so that the amount of water and water vapor transferred to the stack 14 increases. Likewise, a lower humidity of the cathode exhaust gas from the stack 14 occurs because of the higher airflow through the stack 14, which is transferred to the cathode inlet air to the stack 12 through the WVT unit 28.

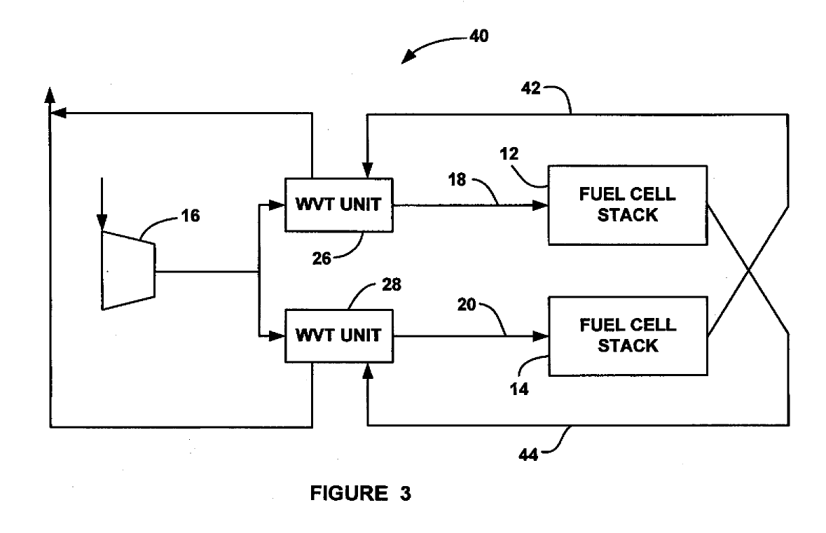

The fuel cell system 34 shows a crossing of the cathode inlet lines to the stacks 12 and 14. In an alternate embodiment, the cathode exhaust gas lines are crossed to achieve the same effect. FIG. 3 is a schematic plan view of a fuel cell system 40 where the cathode exhaust gas line 22 from the stack 12 is replaced with a cathode exhaust gas line 42 and the cathode exhaust gas line 24 from the stack 14 is replaced with a cathode exhaust gas line 44. The cathode exhaust gas from the stack 12 is used to humidify the cathode inlet air to the stack 14 in the WVT unit 28, and the cathode exhaust gas from the stack 14 is used to humidify the cathode inlet air to the stack 12 in the WVT unit 26. Therefore, the humidity balancing between the stacks 12 and 14 is again achieved.

Either embodiment discussed above provides the desired humidity balancing between the stacks 12 and 14. However, the fuel cell system 40 may provide certain advantages in implementation, such as better packaging capabilities.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a first fuel cell stack including a cathode inlet line and a cathode exhaust gas line;
a second fuel cell stack including a cathode inlet line and a cathode exhaust gas line;
a first water vapor transfer unit for providing humidity to a cathode inlet gas flowing through the cathode inlet line for the first stack or the second stack; and
a second water vapor transfer unit for providing humidity to a cathode inlet gas flowing through the other of the first stack or the second stack, wherein the cathode inlet lines and the cathode exhaust gas lines are configured so that the water vapor transfer unit that humidifies the cathode inlet air to one of the fuel cell stacks receives humidification from the cathode exhaust gas in the cathode exhaust gas line from the other fuel cell stack.

2. The system according to claim 1 wherein the first water vapor transfer unit humidifies the cathode inlet gas being sent to the second fuel cell stack, the second water vapor transfer unit humidifies the cathode inlet gas to the first fuel cell stack, the cathode exhaust gas from the first fuel cell stack provides the humidity for the first water vapor transfer unit and the cathode exhaust gas from the second fuel cell stack provides the humidity for the second water vapor transfer unit.

3. The system according to claim 1 wherein the first water vapor transfer unit humidifies the cathode inlet gas to the first fuel cell stack, the second water vapor transfer unit humidifies the cathode inlet gas to the second fuel cell stack, the cathode exhaust gas from the first fuel cell stack provides the humidity for the second water vapor transfer unit and the cathode exhaust gas from the second fuel cell stack provides the humidity for the first water vapor transfer unit.

4. The system according to claim 1 further comprising a single compressor that provides cathode inlet air to both the first fuel cell stack and the second fuel cell stack.

5. The system according to claim 1 wherein the fuel cell system is on a vehicle.

6. A fuel cell system comprising:
a first fuel cell stack including a cathode inlet line and a cathode exhaust gas line;
a second fuel cell stack including a cathode inlet line and a cathode exhaust gas line;
a compressor for providing a cathode inlet airflow to the first fuel cell stack and the second fuel cell stack on the cathode inlet lines;
a first water vapor transfer unit for providing humidity to the cathode airflow for the first fuel cell stack and receiving the cathode exhaust gas on the cathode exhaust gas line from the second fuel cell stack; and
a second water vapor transfer unit for providing humidity to the cathode airflow for the second fuel cell stack and receiving humidity from the cathode exhaust gas on the cathode exhaust gas line from the first fuel cell stack.

7. The system according to claim 6 wherein the fuel cell system is on a vehicle.

8. A fuel cell system comprising:
a first fuel cell stack including a cathode inlet line and a cathode exhaust gas line;
a second fuel cell stack including a cathode inlet line and a cathode exhaust gas line;
a compressor for providing a cathode inlet airflow to the first fuel cell stack and the second fuel cell stack;
a first water vapor transfer unit for providing humidity to the cathode inlet airflow for the second fuel cell stack and receiving the cathode exhaust gas on the cathode exhaust gas line from the first fuel cell stack; and
a second water vapor transfer unit for providing humidity to the cathode inlet airflow for the first fuel cell stack and receiving the cathode exhaust gas on the cathode exhaust gas line from the second fuel cell stack.

9. The system according to claim 8 wherein the fuel cell system is on a vehicle.

10. A method for humidifying the cathode inlet airflow in a fuel cell system, said method comprising:
providing a first fuel cell stack and a second fuel cell stack;
providing a first water vapor transfer unit and a second water vapor transfer unit;
using one of the water vapor transfer units to humidify the cathode inlet airflow for the first or second fuel cell stack; and
using a cathode exhaust gas from the other first or second fuel cell stack to provide the humidity for the one water vapor transfer unit.

11. The method according to claim 10 wherein using one of the water vapor transfer units to humidify the cathode inlet airflow for the first or second fuel cell stack and using a cathode exhaust gas from the other first or second fuel cell stack to provide the humidity for the one water vapor transfer unit includes using the first water vapor transfer unit to humidify the cathode inlet airflow to the first fuel cell stack, using the second water vapor transfer unit to humidify the cathode inlet airflow to the second fuel cell stack, using the cathode exhaust gas from the first fuel cell stack to provide humidity for the second water vapor transfer unit and using the cathode exhaust gas from the second fuel cell stack to provide humidity for the first water vapor transfer unit.

12. The method according to claim 10 wherein using one of the water vapor transfer units to humidify the cathode inlet airflow for the first or second fuel cell stack and using a cathode exhaust gas from the other first or second fuel cell stack to provide the humidity for the one water vapor transfer unit includes using the first water vapor transfer unit to humidify the cathode inlet airflow to the second fuel cell stack, using the second water vapor transfer unit to humidify the cathode inlet airflow to the first fuel cell stack, using the cathode exhaust gas from the first fuel cell stack to provide humidity for the first water vapor transfer unit and using the cathode exhaust gas from the second fuel cell stack to provide humidity for the second water vapor transfer unit.
